(19) United States
(12) Patent Application Publication
(10) Pub. No.: US 2010/0281059 A1
(43) Pub. Date: Nov. 4, 2010

(54) ENHANCED USER PROFILE

(75) Inventor: Liam Sean Lynch, San Jose, CA (US)

Correspondence Address: SCHWEGMAN, LUNDBERG & WOESSNER/EBAY, P.O. BOX 2938, MINNEAPOLIS, MN, 55402, US

(73) Assignee: EBAY INC., SAN JOSE, CA (US)

(21) Appl. No.: 12/434,511

(22) Filed: May 1, 2009

(51) Int. Cl. G06F 17/30; G06F 3/00

(52) U.S. Cl. 707/784; 710/17

(57) ABSTRACT

A method and a system to generate a user profile and an associated profile manager are described. The user profile, in one embodiment, may comprise identity data such as static information about a user and behavior data comprising dynamic information about the user. The profile manager may be configured to monitor the activities of the user through an interface to collect behavior indicators, and to update the behavior data using the collected behavior indicators. In one embodiment, the user profile also comprises reputation data. The method and system may also be configured to receive an access request from a user and selectively grant the access based on the user profile.

### TECHNICAL FIELD

The present application relates generally to the technical field of use of a user profile in a system and, in one specific example, to methods and systems to authenticate and authorize user access to a system.

### BACKGROUND

The Internet and the World Wide Web (“Web”) have changed the landscape of information delivery and affected numerous faculties of life, including electronic commerce and entertainment. One area that has benefited from this technological development is the ability for individuals to buy and sell products over the Internet. The growing electronic commerce has encouraged many businesses to join hands in doing business and in sharing customers and their information. The overlapping businesses, partnerships in conducting business, referrals, mutual distribution of resources, and sharing of users and user information has created a network of applications, servers, and Websites which has created various technical challenges, complexities, and insecurities.

A number of technical challenges exist with respect to authorization and authentication of users and/or systems. For example, conventionally, when a user wishes to access a primary system via a secondary system, the user may be required to first register with the primary system and make a number of assertions associated with the user to the primary system such as name, login name, password, address, phone number, etc. After registering, a user may be required to provide one or more assertions to an authorization system, such as a login name and password, in order to access the primary system. Such conventional authorization systems have several shortcomings, one of which is that they do not prevent access of an unauthorized user that has fraudulently obtained the assertions associated with the user, such as login name and password, of an authorized user. Furthermore, this and other technological challenges also limit the authorization system from gaining a more accurate identification of a user.

### BRIEF DESCRIPTION OF THE DRAWINGS

Some embodiments are illustrated by way of example and not limitation in the figures of the accompanying drawings in which:

FIG. 1 is a block diagram illustrating a network environment within which an example profile manager may be implemented;

FIG. 2 is a block diagram illustrating a profile manager in accordance with one example embodiment;

FIG. 3 is a block diagram illustrating a profile of a user, in accordance with one example embodiment;

FIG. 4 is a flow diagram illustrating a method to store identity data, in accordance with one example embodiment;

FIG. 5 is a flow diagram illustrating a method to update behavior data in a profile of a user, in accordance with one example embodiment;

FIG. 6 is a flow diagram illustrating a method to update reputation data in a profile of a user, in accordance with one example embodiment;

FIG. 7 is a flow diagram illustrating a method to grant a user access based on the user profile in a profile of a user, in accordance with one example embodiment; and

FIG. 8 is a diagrammatic representation of a machine in the example form of a computer system, according to various embodiments.

### DETAILED DESCRIPTION

Example methods and systems to provide authentication and authorization of a user are described. In the following description, for purposes of explanation, numerous specific details are set forth in order to provide a thorough understanding of example embodiments. It will be evident, however, to one skilled in the art that the present invention may be practiced without these specific details.

In an example embodiment, a profile manager will create a user profile for a user containing identity data, behavior data, and reputation data associated with the user. The profile manager may be configured to manage a user profile by generating the profile and keeping it updated based on assertions submitted by the user, behavior and characteristics of the user, and information associated with the user's reputation.

Assertions submitted by a user may include, but is not limited to, a user's name, login name, passwords, addresses (for billing, mailing, etc.), phone numbers, email addresses, identification numbers (such as social security number or driver's license number), or any security keys, certificates, or cookies associated with a security protocol.

Behavior and characteristics of a user may include a wide variety of information that may be used to identify a user. For example, biometric data such as keyboard biometrics or mouse biometrics may be used. Another example of behavior information may include the behavior of a user on a website. For example, on a commerce platform that uses the profile manager, such as a network-based auction platform, the time it takes for a bidding user to pay the purchase price after being notified of his winning bid may be used to update the user profile. Other information such as a method of payment, tendencies to communicate with the seller, timeliness of replies to inquiries, or any other activities that may be tracked over time may be used. In another example, information about the system or environment used by a user may also be utilized beneficially to enhance the accuracy of user identification. This information about the system and the associated environment may include a user system's specifications, operating system, type of anti-virus software (or lack thereof), etc.

Information associated with a user's reputation may be obtained by analyzing user behavior and extracting reputation data based on the analyzed behavior. Reputation data may also be obtained by analyzing comments, feedback, reviews, ratings, or remarks associated with a user.

Reputation data may be better explained using an example embodiment where a commerce platform uses the profile generated by the profile manager, such as a network-based marketplace or trading platform. In this setting, reputation data generated based on collected indicators of a user's behavior may include whether a seller typically ships purchased products in a timely manner, whether the seller responds to buyer inquiries in a timely manner, or any other trait or characteristic that can be determined based on a user's behavior over time. Reputation data may also be obtained by analyzing feedback, reviews, or comments provided by other users of the commerce platform with respect to the user. For example, a buyer may leave feedback about a particular seller or review the seller in response to a questionnaire sent by the commerce platform or posted on a web-page. This information may be used by the profile manager to develop reputation data for the user. The profile manager may also use comments about the user or comments made by the user left on a network-based forum or bulletin board to generate reputation data.

In an example embodiment, a system, such as a commerce platform, may use the user profiles generated by the profile manager to grant a user access to a resource. For example, a user may attempt to sign into their user account on a commerce platform by sending a transaction request from the user's computer to a system server. The system server may then prompt the user for specific information such as a login name and password as well as monitor user behavior such as biometric data such as keyboard biometrics. The user may type in the login name and password on the user's computer's keyboard. The login name and password are sent to the system server along with the keyboard biometric data.

The system server may verify the login name and password submitted to the system server by comparing the login name and password submitted with the login name and password stored in the user profile. The keyboard biometric data received from the user may also be compared to the biometric data stored in the user profile. If the received biometric data corresponds with the biometric data stored in the user profile, the user will be granted access to system resources. If the received biometric data differs from the biometric data stored in the user profile such that they do not correspond, the user may be denied access to system resources, restricted to only certain subset of resources, or be subjected to additional identity verification mechanisms. This allows the system to identify and authenticate a user with more confidence that a user is who he says he is and also allows the system provide additional security by preventing unauthorized access from individuals that have obtained, perhaps fraudulently, another user's information, such as login name and password.

In another example, the system may restrict a user's access to system resources or limit a user's capabilities on the system based on the user's profile. For example, if a user's reputation data stored in their user profile indicates a high risk for fraudulent activity (e.g., the reputation data indicates several poor review comments and feedback from other users), the user may be restricted from selling high priced items on a commerce platform. Example systems to generate and maintain enhanced user profiles may be utilized in the context of a network environment.

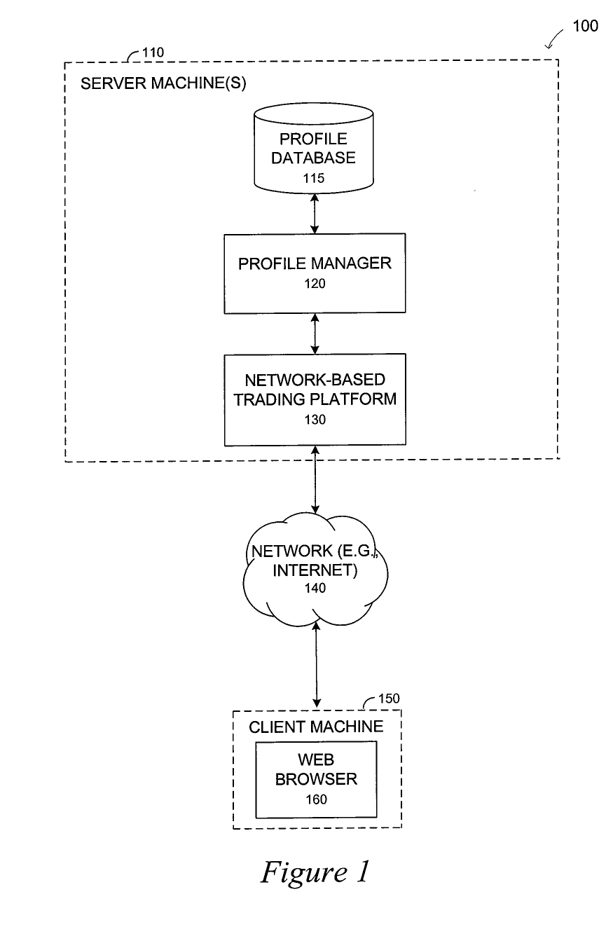

FIG. 1 illustrates a network environment 100, within which an example profile manager may be implemented. The environment 100 may include one or more server machines 110 connected through a network (e.g., the internet) 140 to one or more client machines 150. The server machine 110 may include a profile manager 120, a profile database 115, and a network-based trading platform 130. The network-based trading platform 130 may provide one or more marketplace applications, payment applications, and other resources. The marketplace applications may provide a number of marketplace functions and services to users that access the marketplace. The payment applications, likewise, may provide a number of payment services and functions to users. The network-based trading platform 130 may perform authentication-related functions for authenticating users as well as authorization-related functions for authorizing users to access one or more of the applications, resources, or other capabilities of the platform. The authentication-related functions and authorization functions may be performed based on a user profile that is generated and maintained by the profile manager 120 and stored in the profile database 115.

The client machine 150 may host a web client or a web browser 160. The client machine 150 may be configured to permit a user to access the various applications, resources, and capabilities of the trading platform 130 via a web browser 160.

The embodiments discussed in this specification are not limited to network-based trading platforms however. In other embodiments, other platforms, such as a social networking website or any other system that utilizes user profiles, may be used. Furthermore, more than one platform may be supported by each profile manager and each platform may reside on a separate server machine 110 from the profile manager 120.

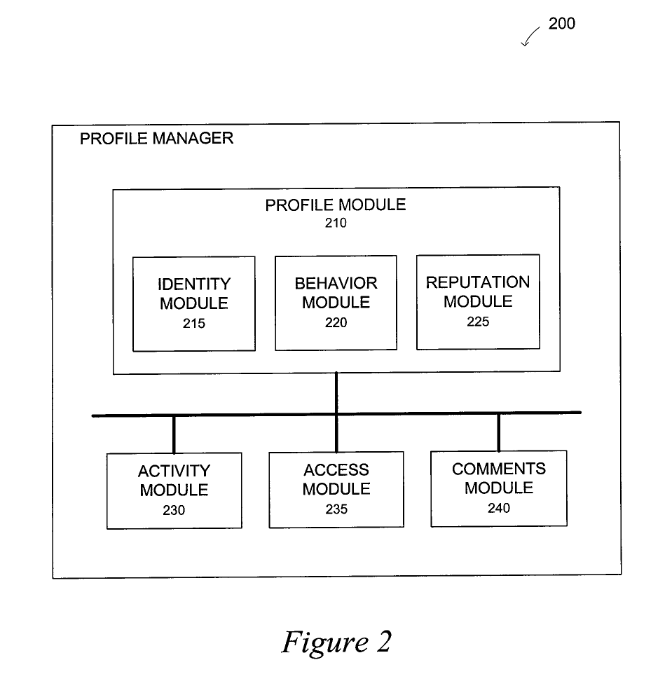

While FIG. 1 illustrates the client machine 150 and the server machine 110 in a client-server architecture, other embodiments are not limited to this architecture, and may equally find applications in a distributed, or peer-to-peer, architectures. An example profile manager may be discussed with reference to FIG. 2.

FIG. 2 is a block diagram illustrating an embodiment of a profile manager 200. The profile manager 200, as shown in FIG. 2, comprises a profile module 210, an activity module 230, a comments module 240, and an access module 235.

The activity module 230 may be configured to monitor activities of a user and collect behavior indicators associated with the activities of the user. The activity module 230 may also be configured to obtain information about a user's system or computing environment.

The comments module 240 may be configured to access comments made by a user or comments associated with a user that are made by others and generate reputation values based on analysis of the comments. These comments may be in the form of feedback, reviews, ratings, messages, etc. They may be extracted from email, physical mail, questionnaires, opinion polls, review web pages, discussion forums, comments pages, etc.

The profile module 210 may be configured to generate a user profile for a user and maintain the user profile such that it is up to date. In one embodiment, profile module 210 comprises an identity module 215, a behavior module 220, and a reputation module 225.

The identity module 215, in one example embodiment, collects information asserted or submitted by a user and stores the collected information as identity data in the profile of the user. The identity module 215 may also monitor the identity data and determine whether the identity data is not up to date.

The behavior module 220 may be configured to generate and update behavior data based on behavior indicators collected by the activity module 230.

The reputation module 225 may be configured to generate reputation data, to store it in the user profile, and to update the reputation data. The reputation module 225 may be configured to generate reputation data based on the behavior data stored in the user profile and behavior indicators collected by the activity module 230. The reputation module 225, in one embodiment, may also generate reputation data based on reputation values based on comments made by a user or comments associated with a user that are made by others. These comments may be in the form of feedback, reviews, ratings, messages, etc. provided, e.g., via a network-based trading platform.

The access module 235 may be configured to authorize a user's access to a resource or capability associated, e.g., with a network-based trading platform. The access module 235, in one embodiment, receives an access request from a user. If there are behavior indicators associated with the access request (e.g., indicators based on the manner the user used a keyboard or a mouse), the access module 235 generates input behavior data based on the collected behavior indicators. The access module 235 relays the access request and input behavior data to the profile module 210 for analysis. The access module 235 may also be configured to grant or restrict user access to one or more system resources or capabilities based on the user's profile.

The modules discussed above and in the rest of this specification may be implemented in hardware, software, or a combination of hardware and software. Furthermore, the modules may or may not reside all on the same machine and may be arranged in configurations not shown in FIG. 2.

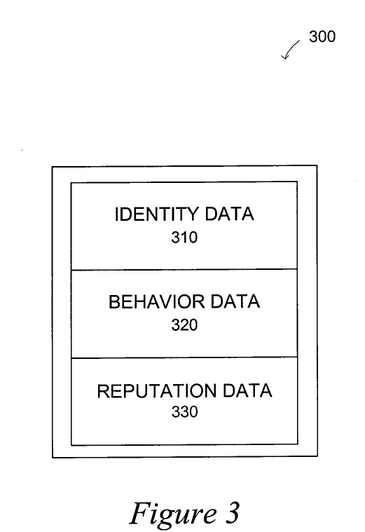

FIG. 3 is a block diagram illustrating an embodiment of a user profile. As shown in FIG. 3, a user profile 300 may comprise identity data 310, behavior data 320, and reputation data 330. The identity data 310 may include information about a user that may be submitted by the user. For example, when a system, (e.g., a network-based trading platform 130 of FIG. 1) registers a new user, the user may be prompted to input certain data such as their name, mailing address, phone numbers, email address, login name, password, security questions and answers, driver's license number, payment accounts, billing addresses, etc. This information may be stored as identity data 310. Identity data 310 is generally more static and does not evolve over time, although it can be updated as required.

Behavior data 320 may include biometric data, such as keyboard biometrics or mouse biometrics. For example, biometric monitoring system may monitor and analyze how a user types certain characters such as a login name and/or password. The way a user uses his mouse may also be monitored. For example, some users may type in a field, move the cursor to the next field using the mouse, and type in the next field. Other users may type in a field, use the “Tab” button on the keyboard to move the cursor to the next field, and type in the next field. Some users may also put their mouse pointer on a certain area of the screen when typing in one or more fields. All this data may be monitored and analyzed over time to generate and update behavior data 320 stored in the user profile 300.

A profile manager may also monitor and analyze a user's activities on one or more websites and use this information to generate and update behavior data 320 in a user profile 300. For example, a user's activities on an online-auction website may be tracked and monitored. The profile manager may track whether a user tends to pay immediately after winning an auction or wait until the payment deadline approaches and a user's preferred method of payment. If the user is a buyer, the profile manager may also track whether the user communicates with the seller, at what point in the transaction process the user communicates, how the user communicates, and the circumstances in which the user communicates to the seller. Alternatively, if the user is a seller, the profile manager can track his communications with a buyer in a similar fashion.

In another embodiment, a profile manager may also generate behavior data 320 based on a user's system information or computing environment that is sent from the user's computer. This information may include a user system's specifications, operating system, type of anti-virus software (or lack thereof), etc.

Reputation data 330 is information about a user that is formed over time and may have a positive or negative connotation. Reputation data 330 may be generated using information extracted from a user's behavior data 320 or other monitored user activity. For example, on an on-line auction website, if a user often fails to pay the purchase price after winning an auction, over time, the profile manager may generate reputation data 330 for the user's profile indicating that the user is an unreliable buyer. Over time, if the user changes his behavior and shows a pattern of timely payment, the profile manager may update the reputation data 330 to reflect that the user is a reliable buyer.

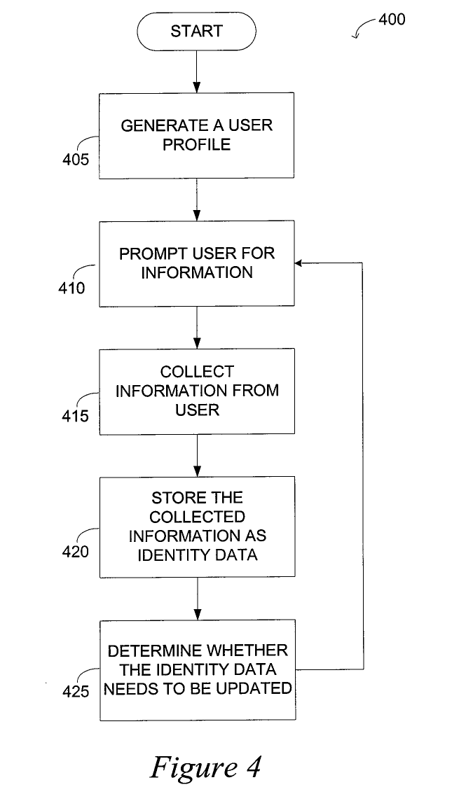

Reputation data 330 may also be generated or updated based on comments associated with a user. This includes comments made by a user (e.g., in the process of using the network-based trading platform 130 of FIG. 1) and comments associated with a user that are made by others. For example, users of a product or service may be able to leave feedback on or reviews of the product or service. If the product or service is associated with a user, a profile manager may be configured to update the user's profile based on the feedback or reviews. The comments may be received by any means, including email, web interface, etc. The comments may be in any form, including a post to a review website or discussion board, a review interface provided by a commerce website, or a response to an electronic questionnaire or survey. Example operations performed by the profile manager 300 may be described with reference to FIGS. 4-6.

FIG. 4 is a flow diagram illustrating an embodiment of a method 400 to store identity data of a user. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server machine 110 of FIG. 1 and, specifically, at the profile manager 200 shown in FIG. 2.

At operation 405, the profile module 210 of FIG. 2 may generate a user profile for a user. At operation 410, a user is prompted for information. For example, a profile manager 200 of FIG. 2 may prompt the user for information, e.g., using an electronic registration form, as part of the registration process in order to permit the user access to the network-based trading platform 130 of FIG. 1. The user may be prompted to input certain data such as their name, mailing address, phone numbers, email address, login name, password, security questions and answers, driver's license number, payment accounts, billing addresses, etc. The profile manager 200 of FIG. 2 may also prompt the user for information if the profile manager 200 determines that the information stored in the user profile is outdated or needs to be updated.

The user can fill out the information requested and submit it to the profile manager 200. At operation 415, an identity module 215 of FIG. 2 collects the information from the user and stores the collected information as identity data in a profile of a user stored in a profile database 115 of FIG. 1 at operation 420. At operation 425, the profile manager 200 determines if the identity data needs to be updated. For example, the identity module 215 may continue to monitor the identity data and determine whether the identity data needs to be updated, or the profile manager 200 may detect a request from the user to update the information stored as identity data in the user profile. If an update is needed, the method returns to operation 410 and the user is prompted for information.

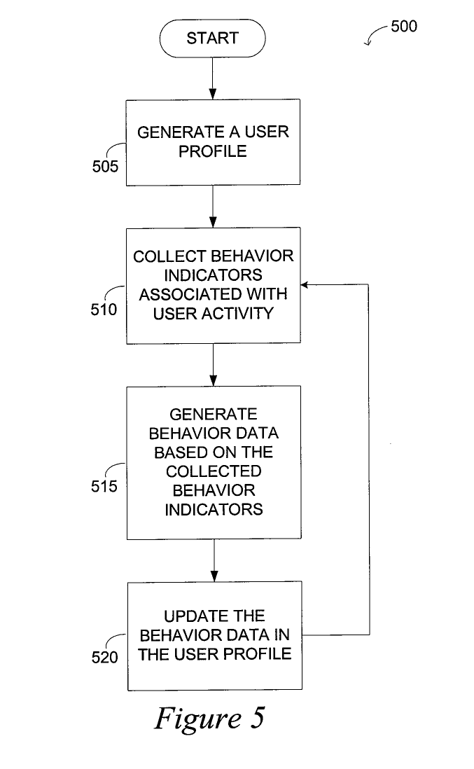

FIG. 5 is a flow diagram illustrating an embodiment of a method 500 to update behavior data. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server machine 110 of FIG. 1 and, specifically, at the profile manager 200 shown in FIG. 2. At operation 505, the profile module 210 of FIG. 2 may generate a user profile for a user. The activity module 230 of FIG. 2 may be configured to monitor user activity and, at operation 510, collect behavior indicators associated with the user activity. For example, the activity module 230 may monitor keyboard input and mouse input from a client machine, user activity on one or more computer systems, or a combination thereof. The activity module 230 may also detect a user's system information or computing environment. The behavior module may generate behavior data based on the collected behavior indicators at operation 515. At operation 520, the behavior module 220 of FIG. 2 updates the behavior data in the user profile. In one embodiment, the activity module 230 is configured to continually monitor user's activity and to continually update the behavior data in the user profile so that the behavior data in the user profile may be kept up to date.

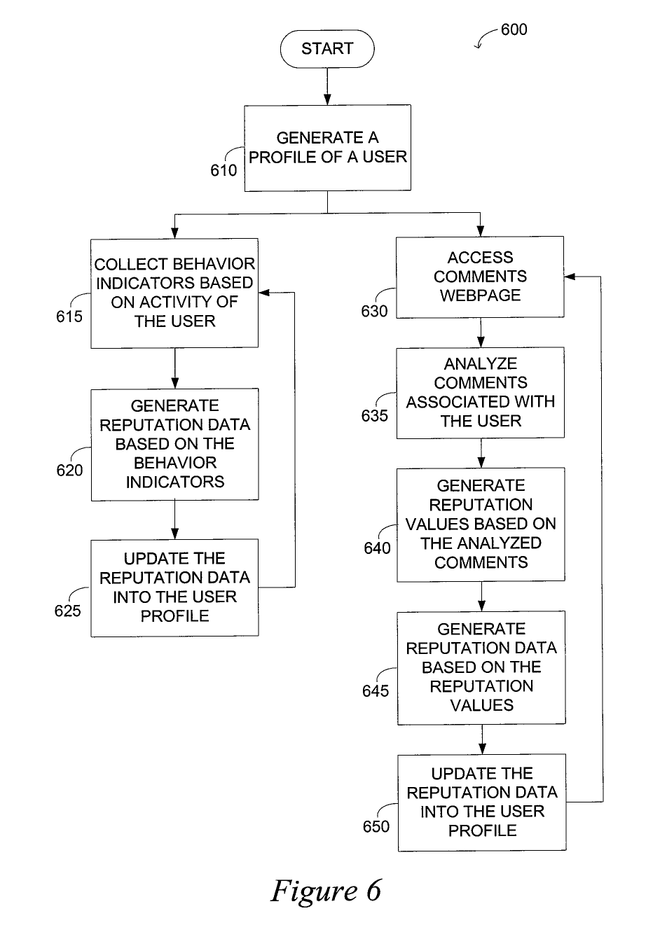

FIG. 6 is a flow diagram illustrating an embodiment of a method 600 to update reputation data. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server machine 110 of FIG. 1 and, specifically, at the profile manager 200 shown in FIG. 2. At operation 610, the profile module 210 of FIG. 2 may generate a user profile for a user. An activity module 230 of FIG. 2 may be configured to monitor user activity and, at operation 615, collect behavior indicators associated with the user activity. For example, as mentioned above, where the profile manager 200 is used the context of an on-line auction platform, the activity module 230 may monitor at what point in time a user pays the purchase price for an auction item after winning the auction. If the user is a seller, the activity module may monitor at what point in time the seller ships a product after the buyer pays the purchase price. In this way, other activities on the on-line auction platform of a user can also be monitored and activities on other platforms may also be monitored. At operation 620, the reputation module may generate reputation data based on the collected behavior indicators and update the reputation data in the user profile at operation 625. In one embodiment, the activity module 230 continues to monitor user activity so that the reputation data in the user profile can be kept up to date.

As mentioned above, reputation data may also be updated based on comments made by a user or comments associated with a user that are made by others. For example, users of a product or service may be able to leave feedback data associated with the user (e.g., feedback on or reviews of products, services, or transactions associated with a user). A profile manager may be able to update the user's profile based on the feedback or reviews. The comments may be posted by any electronic means. In the embodiment of FIG. 6, the comments are made on a comments webpage.

At operation 630, a comments module 240 of FIG. 2 may access a comments webpage and analyze comments associated with a user at operation 635. At operation 640, the comments module 240 generates reputation values based on the analyzed comments. For example, a seller on an online-auction website may have a feedback webpage where buyers can post comments, ratings, reviews, or a combination thereof about a user. The buyers may be able to rate the user based on the accuracy of the description of the product, the quality of communication between the seller, the time it took for the seller to ship the product, etc. Buyers may also be able to leave additional comments messages about a seller. The comments module 240 may generate reputation values based on the comments and ratings. The reputation values may indicate such characteristics as reliability of the product description provided by the user, whether a seller is a prompt shipper, or general buyer satisfaction with a seller. At operation 645, a reputation module 225 of FIG. 2 generates reputation data based on the reputation values and updates the reputation data into the user profile at operation 650.

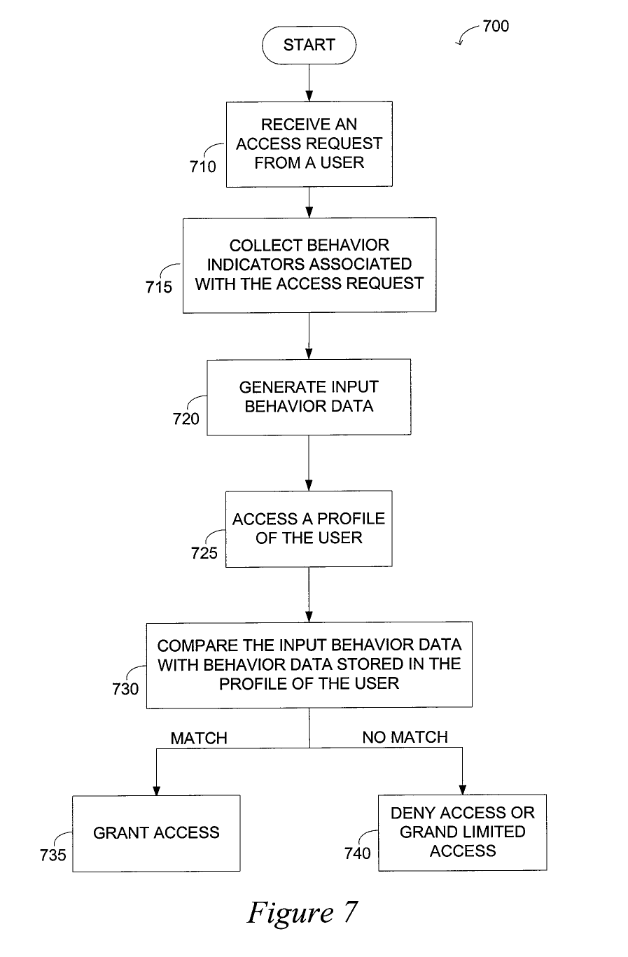

FIG. 7 is a flow diagram illustrating an embodiment of a method to grant a user access based on the user profile. The method 500 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server machine 110 of FIG. 1 and, specifically, at the profile manager 200 shown in FIG. 2. At operation 710, the access module 235 of FIG. 2 receives an access request from a user. The activity module 230 of FIG. 2 detects behavior indicators associated with the request (e.g., a manner in which the user utilized the keyboard or the mouse) and collects the behavior indicators associated with the access request at operation 715. At operation 720, the access module 235 generates input behavior data based on the collected behavior indicators associated with the access request.

At operation 725, the access module 235 of FIG. 2 accesses the profile of the user and compares the input behavior data with the behavior data stored in the profile of the user at operation 730. If there is a match, or if the input behavior data corresponds to the behavior data stored in the user profile, the user is granted the requested access at operation 735. If there is no match and the input behavior data does not correspond to the behavior data stored in the user profile, the user is denied access at operation 740. In one embodiment, there is a match if the input behavior data is similar to the behavior data stored in the user profile within a certain threshold.

In another embodiment, if the input behavior data does not correspond to the behavior data stored in the user profile, the user may be subjected to further security mechanisms or be restricted from certain resources and capabilities of the system. For example, in one scenario where a user attempts to access a system using a login name and password and the collected behavior indicators are the keyboard biometrics for typing in the password, a user's keyboard biometrics may not match the keyboard biometrics for typing in the password stored in the user profile. There could be any number of reasons for this, including a third party stealing the user's login name and password, the user being interrupted or distracted while typing in the password, or the user injuring his hand. In response to the incompatibility of the input behavior data and the behavior data stored in the user profile, the system may prompt the user with additional security questions. This embodiment prevents a user from being denied access to a system if the reason for the input behavior data not corresponding to the behavior data stored in the user profile is innocuous.

In another embodiment, if the input behavior data and the behavior data stored in the user profile do not match, a user may be granted access to only a limited subset of the system resources and capabilities.

In another embodiment, a user's access to system resources or capabilities may also be restricted based on the user's reputation data stored in the user profile. For example, on a social networking platform, a user may leave comments or messages with angry words, threats, or lewd language. A comments module 240 may analyze these comments, and the reputation module 225 of FIG. 2 may generate reputation data based on these comments. The reputation data may indicate poor behavior or a violation of the policies of the social networking platform. As a result, the user may be denied access to the social networking platform, restricted from posting comments or sending messages, restricted from a portion of the website, or be restricted from some other platform resource or capability.

In another example on a network-based auction platform, a user may develop reputation data based on his behavior on an on-line auction platform, the user's comments or messages to other users, or other user's comments associated with the user in the form of feedback, reviews, or ratings. If the reputation data stored in the user profile indicates a tendency for fraud, a user may be denied access to the auction platform or be restricted from some of the auction platform's resources or capabilities. For example, if the user is a buyer, the user may be denied access to the website, restricted from placing bids, restricted from placing bids above a certain amount, or restricted from making bids without ensuring payment if his bid wins. If the user is a seller, the user may be denied access to the website, restricted from placing items for sale, or a warning to buyers may be placed on all his items for sale.

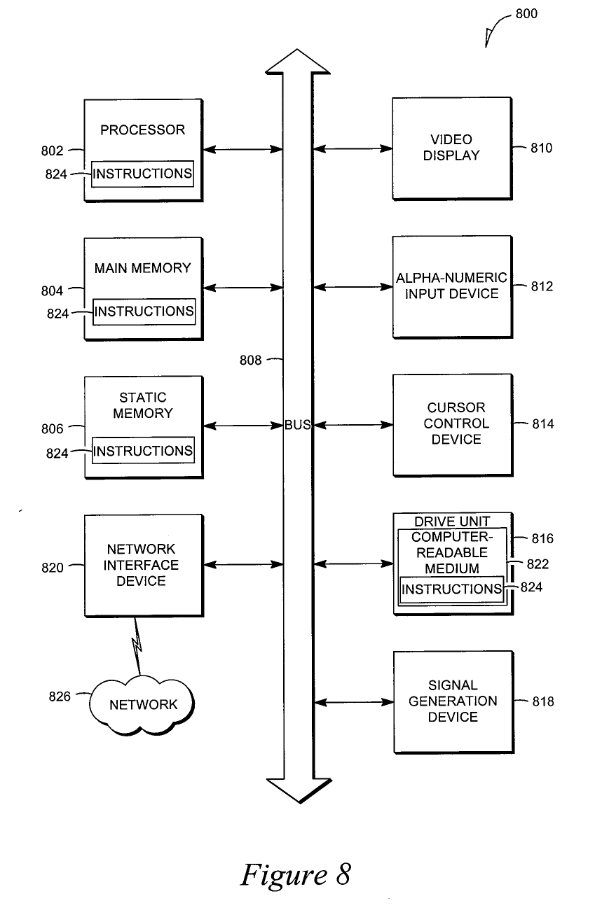

FIG. 8 is a diagrammatic representation of a machine in the example form of a computer system 800 according to various embodiments within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1002 during execution thereof by the computer system 1000, the main memory 1004 and the processor 1002 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for generating and maintaining an enhanced user profile has been described. Although the present invention has been described with reference to specific example embodiments, it will be evident that various modifications and changes may be made to these embodiments without departing from the broader spirit and scope of the invention. For example, while some use cases have been described with reference to a network-based auction platform, the enhanced user profile may be utilized advantageously with other systems where user authentication is taking place. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
an activity module to monitor activities of a user to collect behavior indicators;
a profile module to generate a profile of the user, the profile of the user comprising identity data and behavior data, the identity data comprising static information about the user, and the behavior data comprising dynamic information about the user; and
a behavior module to update the behavior data utilizing the collected behavior indicators.

2. The system of claim 1, wherein the profile of the user also comprises reputation data.

3. The system of claim 2, further comprising a reputation module to update the reputation data based the collected behavior indicators.

4. The system of claim 2, further comprising:
a comment module to analyze feedback data associated with the user about the user and generate one or more reputation values based on the comments; and
a reputation module to update reputation data based on the reputation values.

5. The system of claim 1 wherein the activity module is to monitor at least one of keyboard input and mouse input.

6. The system of claim 1, wherein the activity module is to collect one or more behavior indicators associated with an access request, the system further comprising:
an access module to:
receive an access request from the user;
access the profile of the user;
generate input behavior data based on the collected one or more behavior indicators associated with the access request; and
compare the input behavior data with the behavior data stored in the user profile.

7. The system of claim 6, wherein the access module is to:
determine that the input behavior data corresponds to the behavior data stored in the profile of the user; and
grant the requested access to the user.

8. The system of claim 6, wherein the access module is to:
determine that the input behavior data differs from the behavior data stored in the user profile; and
deny the requested access.

9. The system of claim 6, wherein the access module is to:
determine that the input behavior data differs from the behavior data stored in the user profile; and
grant limited access to the user.

10. The system of claim 2, further comprising an access module to:
receive an access request from a user;
restrict the access of the user based on the profile of the user.

11. A method comprising:
generating a profile of a user through use of one or more processors, the profile of the user comprising identity data and behavior data,
the identity data comprising static information about a user, and
the behavior data comprising dynamic information about the user;
storing the profile of the user in a memory;
monitoring activities of the user through an interface to collect behavior indicators; and
updating the behavior data in the profile of the user using the collected behavior indicators.

12. The method of claim 11, wherein the profile of the user also comprises reputation data.

13. The method of claim 12, further comprising updating the reputation data based the collected behavior indicators.

14. The method of claim 12, further comprising:
analyzing comments associated with the user,
generating one or more reputation values based on the comments, and
updating the reputation data based on the reputation values.

15. The method of claim 11, wherein the monitoring of the activities of the user through the interface comprises monitoring at least one of keyboard input and mouse input.

16. The method of claim 11, further comprising:
receiving an access request from the user;
detecting one or more behavior indicators associated with the access request;
accessing the profile of the user;
generating input behavior data based on the detected one or more behavior indicators; and
comparing the detected behavior data with the behavior data stored in the user profile.

17. The method of claim 16, further comprising:
determining that the input behavior data corresponds to the behavior data stored in the profile of the user; and
granting the requested access to the user.

18. The method of claim 16, further comprising:
determining that the input behavior data differs from the behavior data stored in the profile of the user; and
denying the requested assess.

19. The method of claim 16 further comprising:
determining that the input behavior data differs from the behavior data stored in the user profile; and
granting limited access to the user.

20. The method of claim 12, further comprising:
receiving an access request from a user;
restricting the access of the user based on the profile of the user.

21. An system comprising:
a first means for generating a profile of a user through use of one or more processors, the profile of the user comprising identity data and behavior data, the identity data comprising static information about a user, and the behavior data comprising dynamic information about the user;
a second means for monitoring activities of the user through an interface to collect behavior indicators; and
a third means for updating the behavior data using the collected behavior indicators.

22. A machine-readable medium comprising stored instructions, wherein the instructions, when executed, cause a machine to:
monitor activities of a user to collect behavior indicators;
generate a profile of the user, the profile of the user comprising identity data and behavior data, the identity data comprising static information about the user, and the behavior data comprising dynamic information about the user; and
update the behavior data utilizing the collected behavior indicators.
